(19) United States
(12) Patent Application Publication
(10) Pub. No.: US 2016/0070908 A1
(43) Pub. Date: Mar. 10, 2016

(54) NEXT GENERATION OF SECURITY OPERATIONS SERVICE

(71) Applicant: Microsoft Corporation, Redmond, WA (US)

(72) Inventors: Ashvin Sanghvi, Sammamish, WA (US); Bahadir Baris Onalan, Bellevue, WA (US); Phillip D. Peleshok, Redmond, WA (US); Gaurav Kapila, Redmond, WA (US)

(21) Appl. No.: 14/482,011

(22) Filed: Sep. 10, 2014

(51) Int. Cl. G06F 21/55; G06F 21/62

(52) U.S. Cl. CPC G06F 21/554; G06F 21/6209

(57) ABSTRACT

A security service that detects and handles security breaches in a cloud environment without closing down the whole service is described. A security model for a particular service can be created by defining different types of objects that need to be tracked, defining each object's security states, specifying patterns that trigger security state transitions, providing an automated way to change the security state, and providing an automated response to detection of various states. Suspect objects can be moved from a normal resource pool to a suspect resource pool. Machine learning techniques can be used to learn from processing potential and actual security breaches to improve security for the service.

### BACKGROUND

Computer security (cybersecurity) refers to the processes and mechanisms which attempt to protect computer-based equipment, information and services from unintended or unauthorized access, change or destruction (i.e., from security breaches). Cybersecurity continues to grow in importance as worldwide societal reliance on computer systems increases. The proliferation of cloud and service oriented architecture (SOA) increases the need for cybersecurity while making it more difficult to achieve.

### SUMMARY

A security service that handles potential and actual security breaches without shutting down a subscribing service is described. The security service can be based on a security model that is tailored to a particular service subscribing to the security service (the subscribing service). The security model for the service subscribing to the security service can include definitions of objects and information about a security state machine associated with the objects. Types of objects that can be tracked can be defined, the security states of the tracked objects can be determined, patterns of events that trigger a security state change can be defined, an automated method to effect a security state transition can be provided, an automated response triggered by a security state change can be provided, and one or more suspect objects can be placed in a resource pool reserved for suspect objects while the rest of the service employing the security service continues to run in a “normal” (not suspect) resource pool. In response to determining that a suspect object is actually “bad”, (e.g., fraudulent, unauthorized, etc.) the object can be deleted or other actions can be taken to neutralize the effects of the bad object. Upon determining that a suspect object is not actually “bad”, the object can be returned to the “normal” object pool. Information obtained as a result of processing the suspect object can be used to improve future security.

A collection of security models associated with one or more subscribing services can be continuously built and improved upon, while the associated subscribing service is miming. Like objects including but not limited to data, software and hardware such as computing machines, virtual machines, databases, users, administrators, transactions, networks, etc., can be swapped in and out of use by a particular miming service or portions thereof. Like objects can be used to detect characteristics associated with an observed pattern to identify a “bad” object. Test objects can be intermingled with production objects to enable detection of “bad” objects while isolating effects of a potential or actual breach.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings:

FIG. 1 illustrates an example of a system 100 comprising an example of a security service for breach management in accordance with aspects of the subject matter described herein;

FIG. 2a illustrates an example of a method 200 comprising a method of managing a security breach in accordance with aspects of the subject matter disclosed herein;

FIG. 2b illustrates an example of a method 201 comprising a method of defining a security model in accordance with aspects of the subject matter disclosed herein; and

FIG. 3 is a block diagram of an example of a computing environment in accordance with aspects of the subject matter disclosed herein.

### DETAILED DESCRIPTION

### Overview

In today's world, services and enterprise environments are frequently under attack and to some extent, compromised. Known systems are unable to efficiently address this situation because they typically rely on extraordinary methods such as closing down the whole service to address the breach. Often a large amount of manual processing is needed before normal operation can be resumed. In contrast, in accordance with aspects of the subject matter described herein, breaches are treated as a part of normal operation by a security service. Unaffected portions of services subscribing to the security service can continue to run normally. Normal operation of the security service includes breach management. New security issues can be detected on an ongoing basis, enabling continuous security improvements. Automation for studying and discriminately isolating suspect actors can be generated dynamically.

A security model for a service subscribing to a security service (hereinafter “subscribing service”) can be created by defining: types of objects that can be tracked by the security service, the security state machine associated with each type of object, an automated method to change the security state of an instance of an object and an automated response triggered by a transition to a particular security state. The automated response associated with a security state transition of an object to “suspect”, for example, can include increasing scrutiny or tracking of the object. The increased scrutiny can include removing the object from “normal” (not suspect) objects. The increased scrutiny can include increasing the level of surveillance on the suspect object and/or objects associated with the suspect object. An object determined to be a “confirmed violator” can be neutralized, by for example, deleting the object and any data and objects associated with the bad object that may be compromised.

Suppose, for example a cloud service vendor (CSV) streams courseware to students around the world. The streaming courseware service may be hosted as a multitenant service, meaning that numbers of organizations may subscribe to the streaming courseware service. The CSV may itself subscribe to services (e.g., receive services from other service providers). For example, the CSV may depend on a dynamic service provided by a SaaS (Software as a Service) vendor for customer relations management and/or for collaboration with schools and students. The CSV is likely to need protection from those who seek to perpetrate malicious hack attacks or who try to exploit the service for monetary gain. The CSV may be subject to exploitation by parties who help students cheat and/or steal content or may be subject to exploitation by underground groups who attempt to bring down the service and so on.

The CSV may subscribe to the security service. To use the security service the CSV may import information associated with services to which the CSV subscribes (e.g., a hoster or other service providers) and information associated with organizations and individuals who subscribe to it, (e.g., schools, universities, etc.). In accordance with some aspects of the subject matter described herein, as a result, all or some of the CSV's objects (e.g., a service component) can become protected. A protected object is one that abides by protection policies set by the security service. Some objects can be outside the direct control of the security service. Some service components can be physically or technically incapable of following policies of the security service. The subscribing service may be requested to take action on these objects. Suppose, for example, objects a, b, c, d and e together provide a service. Suppose a subscribing service provides definitions for objects d and e. The subscribing service may have the ability to detect and take actions on objects d and e. The security service may request the subscribing service to take actions such as, for example, to move objects d and e to a designated resource pool. Audit events generated at the subscribing service can be collected by an auditing service of the security service. The auditing service can audit events it receives. The auditing service can generate and/or audit its own auditing events.

A security model for the subscribing service can be developed. Developing the security model for the subscribing service can include defining objects of interest, specifying security states in which a defined object can exist, defining a meaning or impact of each security state, defining a meaning or impact of a transition between security states or a series of transitions between security states. A degree of risk can be associated with a particular security state, with a change from one security state to another security state or with a series of security state changes. Developing the security model can include: defining one or more automated methods that can be employed to discover an object, providing a method to change the security state of an object, providing a method to detect a change in security state of an object, specifying an action or actions to be taken upon detecting a security state change and so on. Security state changes may be triggered by detection of a particular pattern of events. When a suspect pattern is detected, the identity of the bad object is not always apparent. The bad object may be a subscribing service, an administrator, a compromised system, etc. Multiple objects can be associated with a particular suspect pattern. By enabling each of the objects to operate in a separate environment, the bad object can be identified by determining which of the environments continues to be associated with the suspect pattern. The security state of the identified bad object can be changed to “confirmed violator” and the other objects can be returned to the “normal” resource pool.

In response to a security state change from normal to suspect, the level of auditing may be elevated. Similarly, because computing resources are considered fungible, data belonging to a suspect subscribing service can be placed in a pool of resources reserved for suspect services. The data belonging to a suspect subscribing service can be placed in a store reserved for potentially compromised data. Transactions belonging to a suspect subscriber can be sent to a bank of servers reserved for suspect transactions. A suspect administrator can be assigned to a pod reserved for suspect administrators. Moreover, one or more test objects can be intermingled with production objects by introducing them into the environment reserved for suspect objects and pairing them with a suspected object. The actions of the test object and the other object can be compared to determine if the other object behaves normally or if it behaves in a way that is suspicious.

Patterns can be created from extensions to existing patterns. Patterns can be created from patterns of patterns. Patterns can evolve. Creation of new, compound and evolving patterns can continually improve detection of normal, abnormal or potentially or actually bad patterns. Patterns learned from a first subscribing service can be utilized for a second subscribing service. Portions of a security model for a subscribing service that are not instance specific can be applied to other instances of the that type of service. Some patterns may be abstracted so that a pattern that applies to one type of service can be applied to another type of service. For example, suppose a certain pattern is detected that accompanies moving assets from one instance of a service to another instance of a service as the end of a trial period approaches to avoid paying for the service. A general rule that captures this pattern may apply to multiple different services having a trial period. Because compound patterns can be composed from simpler patterns, a service appropriate pattern in a service can be substituted for another pattern detected in a second different service.

Objects of interest to the security service can be defined. The automated actions taken to discover an object can be defined. Objects of interest may be categorized as one or more of the following non-limiting categories: tenant organizations, subscriptions, subscribers, users, administrators, service components, transaction patterns, configuration patterns, etc. The company owning the subscribing service, may, for example, create educational programs that are provided to students electronically. The subscribing service can subscribe to services in addition to the security service. The services to which a subscribing service subscribes are called herein subscriptions. Examples of such service subscriptions can include but are not limited to service providers such as a cloud computing platform (e.g., Microsoft's Azure, Amazon Web Services, etc.). A tenant organization of the subscribing service can be an organization that uses the subscribing service. Examples of tenant organizations for the streaming courseware service can include, for example, universities and schools. Subscribers to the subscribing service can be sub-units of the tenant organization. For the streaming courseware service, the College of Science, the College of Engineering, etc. are examples of possible subscribers. A user can be a user of the service provided by the subscribing service. For example, a user of the streaming courseware service can be a student. A user of the streaming courseware provider can be a lecturer. An administrator can be an employee of the subscribing service that administers some aspect of the technology utilized by the organization. An administrator can be a contractor hired by subscribing service that administers some aspect of the technology utilized by the organization. For example, an administrator can be an employee of the organization or a contractor who manages deployment of software and/or content deployment.

A service component can be a software component. A service component can be data. A service component can be a hardware component or group of hardware components including but not limited to a computing machine, or portion thereof, a virtual machine, a storage device or portion thereof, etc. For example, a service component of the streaming courseware CSV can be a student database. A service component can be a catalog of videos. A transaction signature can be a click stream that is typically associated with a use of the subscribing service. For example, a transaction signature for the streaming courseware provider can be a click stream associated with course enrollment activities, a click stream associated with cheating on a test, a click stream associated with normal courseware updates etc. A clickstream is a recording of the parts of the screen a computer user clicks on while using a software application. As the user clicks in a webpage or application, the action can be logged on a client or inside the web server or web browser, router, proxy server or ad server. A configuration signature can be a collection of expected values for one or more objects. An example of a configuration signature for the streaming courseware service can be that the size of a class at a branch location of a particular university is between 20 and 35. Other examples of configuration signatures are: the number of professors for a course is one or two, the number of technical assistants for a class can be between one and six, the number of individual student computers for a class is typically 30 to 35, etc. Configuration signatures can be used to determine when a condition becomes suspect. For example, if the usual class size is between 20 and 35, and hundreds of students start to enroll in the class, a transition from “normal” to “suspect” may be triggered.

The automation employed to discover an object can be defined. For example, the procedure by which a database is accessed to find a student or group of students, the procedure by which a directory is accessed to discover staff, and/or the procedure by which a configuration management database is accessed to discover computers allowed to access the subscribing service, can be defined. The procedure by which student computers are identified can be defined. The procedure by which a signature of a type of usage is discovered can be defined. State and the meaning of the state can be assigned to the discovered objects. Some of the procedures used to assign state may involve machine learning. Actions associated with different states can be defined. Actions can include but are not limited to a specified level of audit logging. Publishing and researching reports can be generated, alerts can be generated, requests can be routed to queues for manual decision-making, suspect transactions can be routed to isolation service components, suspect objects can be tested using simulated (e.g., test) transactions, the request can be rejected at the source of the request, source IP (internet protocol) ranges can be isolated, objects can be isolated by moving objects to another pod, the request can be routed to forensics and so on.

A resource pool can be all or part of a service component, resource, group of resources, etc. A resource pool can be a fully functional scale unit of the subscribing service, called a pod. A pod, as the term is used herein, is independent, that is, does not depend on any other pod. A pod can enable a service to be scaled. A pod can be used to observe objects or combinations of objects without affecting other pods. A pod can be assigned to process suspect objects. Different levels of suspicious objects can be assigned to different pods. For example, a first pod may process highly suspect objects, a second pod may process less suspect objects and a third pod may process only slightly suspect objects. Objects processed by a pod may include objects from one or more subscribing services.

A particular subscribing service or portions thereof can be assigned to a particular resource pool, perhaps because it is suspect. For example, a particular tenant organization can be determined to be suspect or suspicious because click stream patterns conform with patterns considered suspect. Test traffic can be routed to the subscribing service to determine what object or objects the suspicious patterns are accompanied by. A determination, potentially aided by machine learning techniques, can be made to change the security state of the subscribing service or parts thereof. For example, a possible series of security states assigned to a subscribing service can be unknown to normal to suspect to confirmed violator. In response to determining that the subscribing service is confirmed violator the subscribing service may be removed. Some or all of the data associated with the subscribing service can be removed. Another example of a possible series of states is unknown, normal, suspect, confirmed normal. In response to determining that the state of the subscribing service is “suspect” the subscribing service can be moved to its own resource pool or to a pod processing other “suspect” objects. In response to determining that the state of the subscribing service is “confirmed normal” the subscribing service can be moved out of the “suspect” resource pool and back to a normal resource pool.

Machine learning can be used to continuously find new patterns associated with suspect activity as the subscribing service executes under the security service. Initially, patterns can be loaded into a pattern datastore. The subscribing service may initially categorize the patterns (e.g., determine which patterns are normal, suspect, known or confirmed violator, etc.). Subsequently, patterns can be matched automatically by the security service and security state can be assigned accordingly. Similarly, initially, standardized policies may be loaded into a policy store. Standard reports and dashboards can be provided. The dashboard can display aggregate counts of objects in each state and can allow ordering incidents by risk, where risk is a function of threat severity, business criticality and level of certainty.

In the security service, identification of patterns of user access of the subscribing service can begin. Machine learning can be employed. For the streaming courseware example, patterns of how students use the system, how professors update tests and how service providers update resources can be collected. Suspected fraud (e.g., the same student is taking a large number of classes at the same time or a user is identified as someone who has shared or sold his subscription identifier.) can be identified by the security service and can be reported to the organization offering the subscribing service. As the security service and the subscribing service operate, other outliers can be flagged by the way a school is enrolling students. For example, if a large number of enrollments and course changes are occurring, the associated transactions can be routed to a queue and flagged. In response to determining that the occurrence of large numbers of enrollments and course changes are legitimate, the value denoting the degree of risk associated with the pattern can be demoted or decreased.

Over time, the subscribing service can accumulate a set of patterns of user, service provider and access behavior that can enable audit systems to detect normal, suspect and unauthorized activity and can enable neutralizing actions to be performed when necessary. For example, in the event a suspicious set of content update activity is detected for a school, the school and all its users can be moved to a resource pool reserved for suspect objects. By analysis of historical data, it may be determined that a student has been able to update courseware, infecting computers of all students and/or professors accessing it. Damage can be isolated to the school. In the event a new version of the service software is deployed, regression is not an issue because the security service and knowledge is separately layered. In the management system, the security model can be maintained separately from the service software. In the management system, the automation for discovery, classification and reactive actions can be held separately from the actual service software. Thus, known patterns can be used even after the service software changes.

Patterns of tandem events that occur from different sources can be detected. For example, if a fraudulent administrator sets up a node impersonating a node at a hoster, events that are missing from that tier can be discovered using a transaction identifier assigned to the audit events. The accumulated fraud identification information can be migrated to a new service provider.

### Next Generation of Security Operations Service

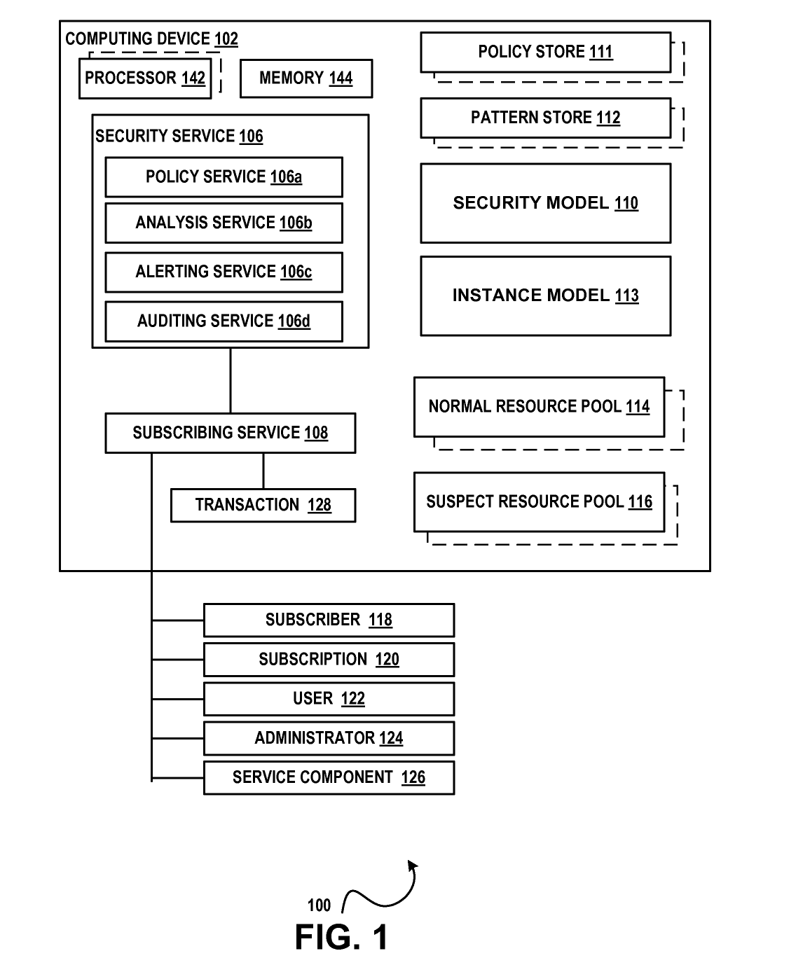

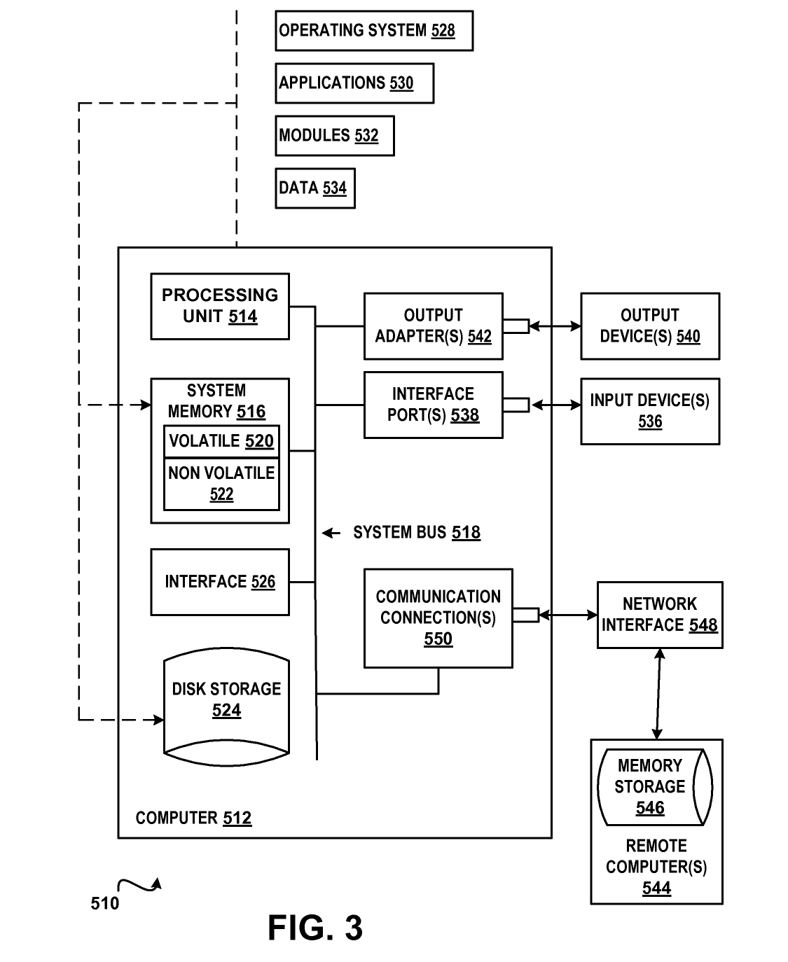

FIG. 1 illustrates an example of a system 100 comprising an example of a security service for breach management in accordance with aspects of the subject matter described herein. All or portions of system 100 may reside on one or more computers or computing devices such as the computers described below with respect to FIG. 3. System 100 or portions thereof may be provided as a stand-alone system or as a plug-in or add-in.

System 100 or portions thereof may include information obtained from a service (e.g., in the cloud) or may operate in a cloud computing environment. A cloud computing environment can be an environment in which computing services are not owned but are provided on demand. For example, information may reside on multiple devices in a networked cloud and/or data can be stored on multiple devices within the cloud.

System 100 can include one or more computing devices such as, for example, computing device 102. Contemplated computing devices include but are not limited to desktop computers, tablet computers, laptop computers, notebook computers, personal digital assistants, smart phones, cellular telephones, mobile telephones, servers, virtual machines, devices including databases, firewalls and so on. A computing device such as computing device 102 can include one or more processors such as processor 142, etc., and a memory such as memory 144 that communicates with the one or more processors.

System 100 may include any one of or any combination of program modules comprising: a security service or operations center such as security service 106. System 100 can also include one or more security models (e.g., security model 110) associated with one or more subscribing services (e.g., subscribing service 108), one or more pattern datastores such as pattern store 112, one or more policy datastores such as policy store 111, one or more sets of computing resources represented in FIG. 1 by normal resource pool 114, etc. and one or more sets of suspect resource pools represented in FIG. 1 by suspect resource pool 116, etc. An organization that provides a service can subscribe to security service 106 to utilize the functionality provided by security service 106. A subscribing service such as subscribing service 108 can be any service that offers functionality to users. A subscribing service 108 may be subscribed to by one or more subscribers such as subscriber 118. Subscribing service 108 can subscribe to one or more subscriptions such as subscription 120, can be used by one or more users such as user 122, administered by one or more administrators such as administrator 124 and utilize one or more service components such as service component 126. In the process of using subscribing service 108, one or more transactions such as transaction 128 can be generated.

Security service 106 may include any one of or any combination of: a policy service such as policy service 106a, an analysis service such as analysis service 106b, an alerting service such as alerting service 106c and/or an auditing service such as auditing service 106d. Security service 106 can monitor and analyze the behavior of one or more services such as subscribing service 108. Security service 106 can in accordance with some aspects of the subject matter described herein, manage the level of oversight over objects representing users, transactions, service components, administrators and subscriptions, etc. to protect the one or more subscribing services. The term “service” as used herein refers to a set of related software functionalities that can be reused for different purposes.

A policy service such as policy service 106a can be a service which assures that the subscribing service is operated according to a set of policies (e.g., stored in policy store 111). Policy service 106a can be implemented as a multitenant SaaS (Software as a Service). An analysis service 106b and/or alerting service 106c can be a service that analyzes data in a real time and/or batched mode in which patterns are automatically discovered by examining audit data collected from audited (tracked) objects. Alerting service 106b can be implemented as a multitenant SaaS (Software as a Service). Alerting service 106b can be a service that alerts the policy service 106a when one or more policies are violated. Auditing service 106d can receive audit events and/or can generate auditing events.

A subscribing service 108 can be any service that subscribes to the security service 106. Subscribing service 108 can include one or more service components such as service component 126. A service component can be any resource that is used to assemble the overall service. Examples of service components include but are not limited to: a virtual machine, a virtual machine tier, a WebRole, a storage device, a storage system, a database, etc. The subscribing service can be owned by an organization. The service can run in a cloud or hoster. A service component can be a protected service component. A protected service component is one that complies with protection policies set by the security service 106. Some service components may be out of the reach of the control of the security service: These types of service components are called unprotected service components. Some service components may be technically incapable of following policies enforced by the security service 106 and are called unprotected service components. A service component can be an audited service component. An audited service component can deliver audit events based on an audit event policy. An unprotected service component may be an audited service component. For example, a contract between a service and the security service may specify that an audit event is generated by a particular unprotected service component. A service component can be a decoy and/or isolation service component. Suspicious requests can be routed to a holding queue. Suspicious traffic can be routed to a suspect resource pool for isolation, queuing or observation purposes.

Before the security system runs, a security model such as security model 110 can be defined. A security model such as security model 110 can be a model that identifies and/or defines one or any combination of: the types of objects that can be discovered and tracked by the security service 106, the different security states in which each type of object can exist, the ways different security states can be detected and the policies to be enacted or actions to be taken in response to a transition from one state to another state for each different object. After the security model 110 is configured, the security service can run for the subscribing service 108. When the security service runs, instances of the different types of objects can be discovered, events can be monitored, and patterns of events associated with one or more objects can be recognized. An instance model (e.g., instance model 113), a dynamic representation of the operating subscribing service can be created. The security state of the object instances can be updated according to the policies of the security model and the actions specified for the state transitions can be performed.

Examples of objects include but are not limited to subscribers, subscriptions, users, administrators, service components, transaction patterns, configuration patterns and so on. Service components can include but are not limited to one or more server computers or banks of server computers. Values associated with the different possible security states of an object include but are not limited to “unknown”, “normal”, “suspect” and “confirmed violator”. Each value may have sub-categories and/or be associated with a degree of risk. The security state of an object can be monitored or tracked by the security service. For example, the security state of an object may progress from “normal” to “suspect” to “normal” based on evaluation of the results of taking the actions defined for the value of the security state of the object under observation. The security state assigned to an object can be based on detection of patterns (e.g., transaction patterns, configuration patterns, etc.). Patterns can be composed from other patterns. Patterns can be patterns developed through machine learning. Patterns can change, grow or be augmented over time as the security system executes. For example, suppose the security service detects that a series of transactions matches a pattern of usage of the subscribing service that is associated with metadata that indicates that this pattern is “suspect”. The state of the object can be changed to suspect.

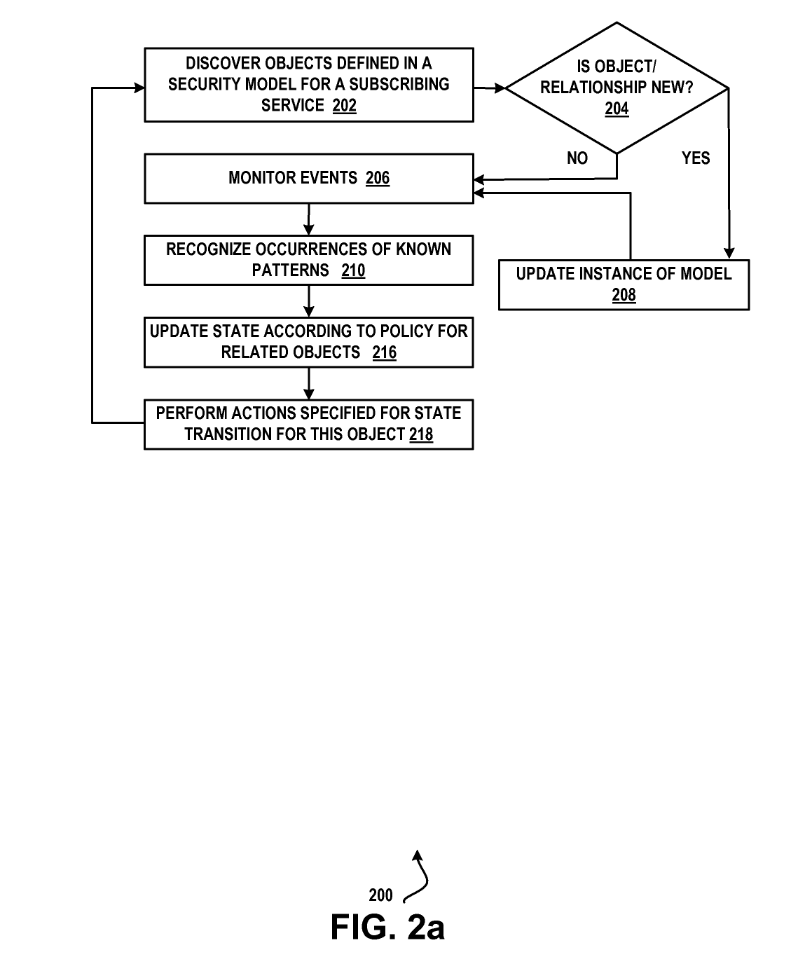

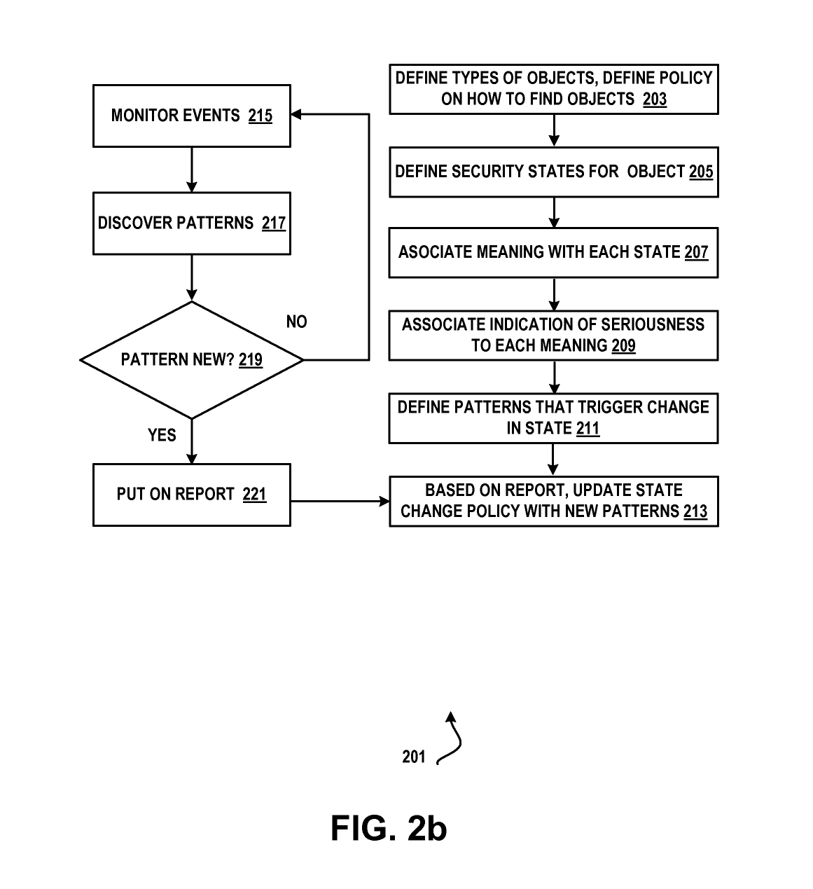

FIG. 2a illustrates an example of a method 200 for performing security breach management in accordance with aspects of the subject matter described herein. The method described in FIG. 2a can be practiced by a system such as but not limited to the one described with respect to FIG. 1. While method 200 describes a series of operations that are performed in a sequence, it is to be understood that method 200 is not limited by the order of the sequence depicted. For instance, some operations may occur in a different order than that described. In addition, one operation may occur concurrently with another operation. In some instances, not all operations described are performed.

At operation 202, a security service can continuously discover objects defined in a security model for a subscribing service. Discovering objects can include finding new objects, removing deleted objects, finding relationships and changes in relationships between objects and recording this information in an instance model which can be used for security state assignments. At operation 204 if a new object or a new relationship between objects is detected, the instance of the security model can be updated at operation 208. At operation 206 events that occur while the security system is running can be monitored. At operation 210 known patterns of events can be recognized. At operation 216 in response to recognizing the occurrence of a known pattern, the security states of the objects can be changed in accordance with a state change policy. In response to detection of a security state transition, actions specified for the security state transition can be performed at operation 218. Actions can include but are not limited to increasing the level of surveillance of the object, moving the object from a normal resource pool to a suspect resource pool, moving the object from the suspect resource pool to the normal resource pool, removing the object etc. For example, suppose a suspect pattern of activity is detected on a host. It may not be apparent if a guest running on the host or the host is the suspicious actor. To isolate the suspicious actor, the guest may be live migrated onto a host with other test guests and/or test guests may be placed on the suspected host. The security service may be allowed to run for a period of time to see where the suspect pattern of activity recurs, thus making it possible to isolate the bad actor. Similarly, transactions associated with a suspect customer or tenant can be routed to another processing pool (e.g., to a particular group of servers, for example) or a tenant's state (data) may be routed to a shard (a partition of a database) reserved for suspected actor's data. Processing can continue at operation 202.

FIG. 2b illustrates an example of a method 201 for developing and/or maintaining a security model in accordance with aspects of the subject matter described herein. The method described in FIG. 2b can be practiced by a system such as but not limited to the one described with respect to FIG. 1. While method 201 describes a series of operations that are performed in a sequence, it is to be understood that method 201 is not limited by the order of the sequence depicted. For instance, some operations may occur in a different order than that described. In addition, one operation may occur concurrently with another operation. In some instances, not all operations described are performed. Method 201 or portions thereof may be performed before a security service for a subscribing service is placed in service. Method 201 or portions thereof may be performed after the security service is placed in service but while the security service and/or subscribing service is off-line. Method 201 or portions thereof may be performed after a security service is placed in service while the security service and/or subscribing service is operating. At operation 203 types of objects that can be tracked by the security service can be defined. For each different type of object, at operation 205 different security states for the type of object can be defined. At operation 207 meanings can be associated with each different state for that type of object. At operation 209 an indication of the seriousness of each different meaning for the indication can be provided. At operation 211 patterns that trigger a change in state for an object or group of objects can be defined. Methods including but not limited to: how to find each type of object, how to change the state of an object, actions to take upon detecting a change in state or series of changes in state, etc. can be provided. This operation can include providing transaction signatures or patterns for suspect transactions. This operation can include providing configuration signatures or patterns for suspect configurations. Operations 205 through 211 can be repeated for each object. Operations 203, 205, 207, 209 and 211 can comprise operations that create (author) a security model prior to running the security system. At operation 215, events recorded while the security system is in operation can be monitored or reviewed. At operation 217, the events can be analyzed (e.g., using machine learning techniques) to discover new patterns. At operation 219 in response to determining that a pattern is new, the sequence of events can be placed on a report at operation 221. At operation 213, the report generated at operation 221, after the security system is operational, can be used to update state change policy with the new patterns. Operations 203, 205, 207, 209, 211 and 213 can be performed to maintain the security model. Operations 203, 205, 207, 209, 211 and 213 may take place while the security system is miming or while the security system is offline.

### Example of a Suitable Computing Environment

In order to provide context for various aspects of the subject matter disclosed herein, FIG. 3 and the following discussion are intended to provide a brief general description of a suitable computing environment 510 in which various embodiments of the subject matter disclosed herein may be implemented. While the subject matter disclosed herein is described in the general context of computer-executable instructions, such as program modules, executed by one or more computers or other computing devices, those skilled in the art will recognize that portions of the subject matter disclosed herein can also be implemented in combination with other program modules and/or a combination of hardware and software. Generally, program modules include routines, programs, objects, physical artifacts, data structures, etc. that perform particular tasks or implement particular data types. Typically, the functionality of the program modules may be combined or distributed as desired in various embodiments. The computing environment 510 is only one example of a suitable operating environment and is not intended to limit the scope of use or functionality of the subject matter disclosed herein.

With reference to FIG. 3, a computing device in the form of a computer 512 is described. Computer 512 may include at least one processing unit 514, a system memory 516, and a system bus 518. The at least one processing unit 514 can execute instructions that are stored in a memory such as but not limited to system memory 516. The processing unit 514 can be any of various available processors. For example, the processing unit 514 can be a graphics processing unit (GPU). The instructions can be instructions for implementing functionality carried out by one or more components or modules discussed above or instructions for implementing one or more of the methods described above. Dual microprocessors and other multiprocessor architectures also can be employed as the processing unit 514. The computer 512 may be used in a system that supports rendering graphics on a display screen. In another example, at least a portion of the computing device can be used in a system that comprises a graphical processing unit. The system memory 516 may include volatile memory 520 and nonvolatile memory 522. Nonvolatile memory 522 can include read only memory (ROM), programmable ROM (PROM), electrically programmable ROM (EPROM) or flash memory. Volatile memory 520 may include random access memory (RAM) which may act as external cache memory. The system bus 518 couples system physical artifacts including the system memory 516 to the processing unit 514. The system bus 518 can be any of several types including a memory bus, memory controller, peripheral bus, external bus, or local bus and may use any variety of available bus architectures. Computer 512 may include a data store accessible by the processing unit 514 by way of the system bus 518. The data store may include executable instructions, 3D models, materials, textures and so on for graphics rendering.

Computer 512 typically includes a variety of computer readable media such as volatile and nonvolatile media, removable and non-removable media. Computer readable media may be implemented in any method or technology for storage of information such as computer readable instructions, data structures, program modules or other data. Computer readable media include computer-readable storage media (also referred to as computer storage media) and communications media. Computer storage media includes physical (tangible) media, such as but not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices that can store the desired data and which can be accessed by computer 512. Communications media include media such as, but not limited to, communications signals, modulated carrier waves or any other intangible media which can be used to communicate the desired information and which can be accessed by computer 512.

It will be appreciated that FIG. 3 describes software that can act as an intermediary between users and computer resources. This software may include an operating system 528 which can be stored on disk storage 524, and which can allocate resources of the computer 512. Disk storage 524 may be a hard disk drive connected to the system bus 518 through a non-removable memory interface such as interface 526. System applications 530 take advantage of the management of resources by operating system 528 through program modules 532 and program data 534 stored either in system memory 516 or on disk storage 524. It will be appreciated that computers can be implemented with various operating systems or combinations of operating systems.

A user can enter commands or information into the computer 512 through an input device(s) 536. Input devices 536 include but are not limited to a pointing device such as a mouse, trackball, stylus, touch pad, keyboard, microphone, voice recognition and gesture recognition systems and the like. These and other input devices connect to the processing unit 514 through the system bus 518 via interface port(s) 538. An interface port(s) 538 may represent a serial port, parallel port, universal serial bus (USB) and the like. Output devices(s) 540 may use the same type of ports as do the input devices. Output adapter 542 is provided to illustrate that there are some output devices 540 like monitors, speakers and printers that require particular adapters. Output adapters 542 include but are not limited to video and sound cards that provide a connection between the output device 540 and the system bus 518. Other devices and/or systems or devices such as remote computer(s) 544 may provide both input and output capabilities.

Computer 512 can operate in a networked environment using logical connections to one or more remote computers, such as a remote computer(s) 544. The remote computer 544 can be a personal computer, a server, a router, a network PC, a peer device or other common network node, and typically includes many or all of the elements described above relative to the computer 512, although only a memory storage device 546 has been illustrated in FIG. 3. Remote computer(s) 544 can be logically connected via communication connection(s) 550. Network interface 548 encompasses communication networks such as local area networks (LANs) and wide area networks (WANs) but may also include other networks. Communication connection(s) 550 refers to the hardware/software employed to connect the network interface 548 to the bus 518. Communication connection(s) 550 may be internal to or external to computer 512 and include internal and external technologies such as modems (telephone, cable, DSL and wireless) and ISDN adapters, Ethernet cards and so on.

It will be appreciated that the network connections shown are examples only and other means of establishing a communications link between the computers may be used. One of ordinary skill in the art can appreciate that a computer 512 or other client device can be deployed as part of a computer network. In this regard, the subject matter disclosed herein may pertain to any computer system having any number of memory or storage units, and any number of applications and processes occurring across any number of storage units or volumes. Aspects of the subject matter disclosed herein may apply to an environment with server computers and client computers deployed in a network environment, having remote or local storage. Aspects of the subject matter disclosed herein may also apply to a standalone computing device, having programming language functionality, interpretation and execution capabilities.

The various techniques described herein may be implemented in connection with hardware or software or, where appropriate, with a combination of both. Thus, the methods and apparatus described herein, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing aspects of the subject matter disclosed herein. As used herein, the term “machine-readable storage medium” shall be taken to exclude any mechanism that provides (i.e., stores and/or transmits) any form of propagated signals. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects, e.g., through the use of a data processing API or the like, may be implemented in a high level procedural or object oriented programming language to communicate with a computer system. However, the program(s) can be implemented in assembly or machine language, if desired. In any case, the language may be a compiled or interpreted language, and combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system comprising:
at least one processor:
a memory connected to the at least one processor; and
a security service comprising:
at least one program module loaded into the memory, the at least one program module monitoring a security state transition of an object in a service subscribing to the security service, the security service handling security breaches of the subscribing service without shutting down the subscribing service; and
at least one program module loaded into the memory that in response to detecting a security state transition indicating a potential breach, moves the object from a first resource pool reserved for not suspect objects to a second resource pool reserved for suspect objects.

2. The system of claim 1, further comprising at least one program module that creates a security model tailored to the subscribing service.

3. The system of claim 1, further comprising at least one program module comprising a policy service that applies policies for the subscribing service.

4. The system of claim 1, further comprising at least one program module that analyzes data in which patterns are automatically discovered using audit data collected from audited service components and service providers associated with the subscribing service.

5. The system of claim 1, further comprising at least one program module that in response to confirming that a suspect object is suspicious, takes actions to neutralize effects of the suspect object.

6. The system of claim 1, further comprising at least one program module that updates a datastore of transaction patterns while the subscribing service is running based on information learned from processing the object.

7. The system of claim 2, wherein the security model is created by defining types of objects in the subscribing service, defining security states for each type of object, specifying how each type of object can be found, and specifying actions to take when a security state transition of the object is detected.

8. A method comprising:
monitoring by a processor of a computing device an executing service, the executing service subscribing to a security service that handles security breaches without shutting down the service subscribing to the security service based on a security model tailored to the executing service; and
in response to detecting a security state transition of an object in the executing service, the security state transition indicating a possible breach, moving the object from a normal resource pool to a suspect resource pool.

9. The method of claim 8, further comprising:
in response to receiving subscriptions of the service subscribing to the security service, monitoring the subscriptions.

10. The method of claim 8, further comprising:
receiving a security model tailored to the service subscribing to the security service, the security model:
defining types of objects in the service subscribing to the security service,
defining security states for each type of object,
specifying how each type of object can be found,
specifying patterns that trigger a state change; and
specifying actions to take when a security state transition for the object is detected.

11. The method of claim 8, further comprising:
automatically discovering patterns using audit data collected from audited service components and service providers associated with the service subscribing to the security service.

12. The method of claim 8, further comprising:
using machine learning techniques to determine patterns associated with security breaches in the service subscribing to the security service.

13. The method of claim 12, further comprising:
using patterns discovered by processing potential security breaches in the service subscribing to the security service to improve the security model.

14. A computer-readable storage medium comprising computer-readable instructions which when executed cause at least one processor of a computing device to:
monitor a subscribing service, the subscribing service subscribing to a security service, the security service handling security breaches without shutting down the subscribing service; and
in response to detecting a security state transition of an object in the executing service, the security state transition indicating a possible security breach, moving the object from a normal resource pool to a suspect resource pool.

15. The computer-readable storage medium of claim 14, comprising further computer-readable instructions which when executed cause the at least one processor to:
receive a security model tailored to the subscribing service, the security model comprising:
definitions of types of objects in the subscribing service,
security states for each type of object,
actions to take to find each type of object, and
actions to take when a security state transition of the object is detected.

16. The computer-readable storage medium of claim 14, comprising further computer-readable instructions which when executed cause the at least one processor to:
move a first suspect object associated with a first degree of risk to a first suspect resource pool; and
move a second suspect object associated with a second degree of risk to a second suspect resource pool.

17. The computer-readable storage medium of claim 14, comprising further computer-readable instructions which when executed cause the at least one processor to:
monitor subscriptions of the subscribing service.

18. The computer-readable storage medium of claim 14, comprising further computer-readable instructions which when executed cause the at least one processor to:
use machine learning techniques to gather a body of knowledge associated with security breaches in the subscribing service.

19. The computer-readable storage medium of claim 14, comprising further computer-readable instructions which when executed cause the at least one processor to:
move suspicious transactions to a holding queue.

20. The computer-readable storage medium of claim 14, comprising further computer-readable instructions which when executed cause the at least one processor to:
intermingle test objects with production objects in the subscribing service to identify suspect objects.
